(19) United States
(12) Patent Application Publication
(10) Pub. No.: US 2007/0099492 A1
(43) Pub. Date: May 3, 2007

(54) Easy-access service outlet housings

(76) Inventor: Eric Clifton, Escondido, CA (US)

Correspondence Address: BIOTECHNOLOGY LAW GROUP;C/O PORTFOLIOIP, PO BOX 52050, MINNEAPOLIS, MN, 55402, US

(21) Appl. No.: 11/590,621

(22) Filed: Oct. 30, 2006

Related U.S. Application Data
(60) Provisional application No. 60/732,692, filed on Nov. 1, 2005.

(51) Int. Cl. H01R 13/60

(52) U.S. Cl. 439/535

(57) ABSTRACT

Integrated service outlet housings that include at least one user access chamber and at least one component chamber substantially adjacent to the user access chamber are described. These housings are suitable for use with conventional construction framing materials and techniques. Each user access chamber is typically formed from a back wall and one or more sidewalls extending or protruding from the upper surface of the back wall. Component chambers are adapted for housing at least one service outlet, and also comprise a back wall and one or more sidewalls extending therefrom. Each component chamber also comprises at least one wire port, thus enabling the connection of the service outlet(s) disposed therein to the appropriate wiring.

### TECHNICAL FIELD

This invention concerns housings for service outlets, such as electrical receptacles, electric switches, and data ports.

### BACKGROUND OF THE INVENTION

1. Introduction.

The following description includes information that may be useful in understanding the present invention. It is not an admission that any such information is prior art, or relevant, to the presently claimed inventions, or that any publication specifically or implicitly referenced is prior art.

2. Background.

Today, many electrical appliances, such as flat screen computer or television monitors, clocks, telephones, and stereo components, are designed to be mounted directly to a building wall. In most cases, the electrical cable(s) or cord(s) for connecting the appliance to the necessary service(s) (e.g., electrical service, cable or satellite service, telephone service, etc.) have plugs or other attachment elements at their distal ends that result in the cable or cord protruding from the wall, making flush mounting of the electrical appliance difficult or impossible without providing sufficient space between the rear of the appliance and the wall so as to allow the cable or cord sufficient space to bend.

To address this problem, appliances or their mounting brackets have been developed to provide the requisite space to make the necessary service connections. Another approach has been to manufacture outlet boxes that allow an electrical receptacle, for example, to be recessed in the wall, thereby allowing the plug end of an electrical cable, telephone wire, television cable, etc. to be inserted into the cavity provided by the recessed outlet. However, even these outlet boxes fail to provide easy access to the chamber or compartment in which the service outlet must be disposed and in which the necessary connections must be made in order to connect the receptacle, for example, to the electrical wiring in the wall.

3. Definitions.

Before describing the instant invention in detail, several terms used in the context of the present invention will be defined. In addition to these terms, others are defined elsewhere in the specification, as necessary. Unless otherwise expressly defined herein, terms of art used in this specification will have their art-recognized meanings.

The term “adjacent” means that two or more components are bordering, neighboring, or immediately adjoining, without intervening space. The term “substantially adjacent” means that two or more components are bordering, neighboring, or adjoining, although they may be separately by one or more cavities in the wall between them.

A “cable” or “wire” refers to a conductor, together with any associated insulation and/or shielding, that carries electricity or light over a distance. The conductor may be comprised of one or many strands of material (e.g., glass, copper, etc.), depending on the particular application. Representative examples include fiber optic cable, coaxial cable, and electrical wire.

A “component chamber” means the compartment, or other housing in which the body of a service outlet is disposed when installed in an integrated service outlet housing according to the invention.

“Conventional construction framing” refers to techniques used to frame walls during the construction of various buildings, such as residential and office buildings. For example, conventional homes are generally built using wood or steel frame construction techniques that utilize members often referred to as “two by fours”, or “2×4'”, of varying lengths. Traditionally, these numbers referred to the width and depth dimensions, in inches, of the finished lumber used for construction. More recently, while these same terms remain in use, the actual width and depth dimensions of a finished, construction grade 2×4 wall stud are about 1.5 inches and about 3.5 inches, respectively. Thus, once wall board or another material has been attached to the studs, the interior wall space defined by the inner surfaces of the wallboard, for example, has a maximum depth of about 3.5 inches. It will also be appreciated that structures (e.g., homes, offices, retail space, etc.) can also be built using other construction techniques. For example, panelized wall systems, poured-in-place concrete, etc. can also be used for construction of buildings. To the extent such techniques can produce or utilize walls having an interior depth dimension of less than about 4.5 inches, preferably about 3.5 inches or less, such other techniques will also be considered “conventional construction framing” for purposes of the claimed invention.

A “data port” means any port used for data communications. Data may be encoded in electrical or optical forms, and includes audio data (e.g., voice, music, etc.), image or video data, and any other data type. Representative data ports include infrared, serial, and parallel ports, telephone jacks (e.g., an RJ-11 telephone socket that provides an outside line for sending data or a fax via modem), an ethernet jack (i.e., a jack adapted to receive the plug disposed at one end of an ethernet cable), and a jack for accepting an RCA plug (i.e., a CINCH/AV connector).

An “electrical switch” means refers to a component in an electric circuit that controls the flow electricity through the circuit by opening (i.e., interrupting or “turning off” the flow of electricity in the circuit) or closing (i.e., making the connection(s) necessary to allow electricity to flow in the circuit) the switch. Electrical switches can be of the single or multi-pole variety.

An “electrical receptacle” means a device that enables an electrical appliance (i.e., a device that requires electrical energy for operation) to be connected to a source of electrical energy. In general, they are contact electrical devices for connection of an attachment plug of an electrical appliance. Most common electrical receptacles found in homes and offices have two contact devices, and are termed “duplex receptacles”. Electrical receptacles for delivery of various voltages are well known in the art.

The term “fixedly” refers to the attachment of one item to another, preferably in a secure fashion. Various approaches may be used for fixed attachment of two or more items, including bonding (for example, through the use of various adhesives, epoxies, etc.) or the use of various fasteners, including nails and screws suited for the particular application.

The term “functional association” refers to the bringing together of two or more items in a way such that, once associated, the items are capable of their intended function(s).

A “housing” means a structure or container designed to contain one or more particular components, for example, a service outlet such as an electrical receptacle, a light switch, and/or a data port.

An “integrated” service outlet housing refers to one in which the user

A “jack” and a “plug” refer to a representative pair of electrical or optical connectors useful in the context of this invention. A “jack” refers to a female socket adapted to receive a corresponding male “plug”. For example, a “telephone jack” refers to the socket into which a “plug” at one end of a telephone wire can be inserted to provide the necessary electrical contacts for data transmission through the jack and wire.

A “mounting bracket” refers to structure, typically integrated as part of a larger structure, used for mounting or otherwise attaching the larger structure to a different structure. For example, a mounting bracket integrated into an integrated service outlet housing according to the invention can be used to attach the housing to a wall stud.

A “patentable” composition, process, machine, or article of manufacture according to the invention means that the invention as claimed satisfies all statutory requirements for patentability at the time the particular analysis is performed. For example, with regard to novelty, non-obviousness, or the like, if post-issuance investigation reveals that one or more claims encompass one or more embodiments that would negate novelty, non-obviousness, etc., the claim(s), being limited by definition to “patentable” embodiments, specifically exclude the unpatentable embodiment(s). Also, the claims appended hereto are to be interpreted both to provide the broadest reasonable scope, as well as to preserve their validity. Furthermore, if one or more of the statutory requirements for patentability are amended or if the standards for assessing whether a particular statutory requirement for patentability is satisfied change from the time this application is filed or issues as a patent to a time the validity of one or more of the appended claims is questioned, the claims are to be interpreted in a way that (1) preserves their validity and (2) provides the broadest reasonable interpretation under the circumstances.

A “plurality” means more than one.

A “polygon” refers to a figure formed by three or more intersecting sides.

A “receptacle” means an electrical or electronic fitting that is connected to, for example, a source of power and/or data, and is adapted for and is equipped to receive a connector, for example, an electrical plug disposed at the end of an electrical cable or wire, such that electricity and/or data can flow or otherwise be transmitted from the fitting, through the conductor, and to the cable or wire to which the connector is attached.

The term “rectangle” or “rectangular” refers to a four-sided polygon whose sides are at right angles to each other, i.e., it is a four-sided polygon with four right angles. When the sides are of equal length, the rectangle is called a “square”. The term “substantially rectangular” refers to a four-sided figure whose sides are at substantially right angles to each other. Here, a “substantially right angle” refers to an angle that is 90 degrees, plus or minus 10 degrees.

A “service outlet” means any device adapted for connection of an electrical appliance to a service, including electrical service, telephone service, cable service, satellite service, and the like. Representative examples of service outlets include electrical receptacles, data ports, etc.

The term “trim piece” refers to an article intended for attachment to an integrated service outlet housing according to the invention for the purpose of concealing the contents within the component chamber(s) of the housing. Preferably, a trim piece will provide a finished appearance to the service outlet housing to which it is attached, in a manner analogous to that of a faceplate used in conjunction with an electrical receptacle or wall-mounted light switch.

The term “trim piece attachment element” refers to an element on an integrated service outlet housing according to the invention that may be used for attachment of a trim piece.

A “user access chamber” means a chamber from or in which a user can gain access to the receptacles(s) of the one or more service outlets disposed to the particular integrated service outlet housing according to the invention.

A “wire port” means a hole, slot, or other opening in a component chamber through which one or more wires can be inserted into the chamber. Such ports are preferably fully or partially formed into a wall of the component chamber during the manufacturing process. Partially formed ports include “knockouts” and the like.

### SUMMARY OF THE INVENTION

It is an object of this invention to provide integrated, one-piece service outlet housings that allow recessed connection between an appliance and a service outlet and ready access to the compartment(s) in which the service connection(s) must be made between a service outlet and the particular service to be provided, e.g., electrical service, television service, a high speed Internet connection, telephone service, audio service, etc.

Thus, one aspect of the invention concerns patentable integrated service outlet housings that include at least one user access chamber and at least one component chamber substantially adjacent to the user access chamber. Each user access chamber is typically formed from a back wall and one or more sidewalls extending or protruding from the upper surface of the back wall. Component chambers are adapted for housing at least one service outlet, and also comprise a back wall and one or more sidewalls extending therefrom. Each component chamber also comprises at least one wire port, thus enabling the connection of the service outlet(s) disposed therein to the appropriate wiring. The service outlet housings of the invention are configured for use with conventional construction framing.

In some preferred embodiments, the upper surfaces of back walls of the user access chamber(s) and component chamber(s) reside in the same plane, whereas in others, the reside in different planes.

In many preferred embodiments, a user access chamber shares a sidewall (or portion thereof) with a component chamber. In such embodiments, the shared side wall (or portion thereof) will have at least one opening for disposition of the service outlet(s) in the component chamber such that a user can access the plugs, jacks, or other connections on service outlet needed for connecting the desired appliance type thereto.

Typically, a user access chamber will comprise sidewalls that, together, form a polygon. Alternatively, when viewed from above, the user access chamber may be formed by a sidewall having an elliptical or ovoid, preferably a circular, shape. Of course, the shape of a user access chamber, when viewed from the front, can be any desired shape. In preferred embodiments, the sidewalls form a 3-, 4-, 5-, 6-, 7-, 8-, 9-, or 10-sided structure when viewed from the front that, together with the back wall, form an open box the interior of which can readily be accessed following attachment to a wall stud, even after wall board or another surfacing material is attached to the framing used to form the wall structure. In particularly preferred embodiments, the user access chamber includes four sidewalls that, together with the back wall, form a substantially rectangular open box.

As will be appreciated, sidewalls of user access chambers and/or component chambers may extend at any desired angle from their associated back walls. In some of these embodiments, the angle formed between a sidewall and the back wall may be obtuse, whereas in other, it may be acute. In preferred embodiments, the sidewalls extend substantially perpendicularly from the back wall. Here, “substantially perpendicular” means 90 deg, plus or minus 5 deg., “acute” means an angle that is less than about 85 deg., and obtuse means an angle that is greater than about 95 deg.

Many embodiments of the invention concern integrated service outlet housings wherein a component chamber is adapted for housing a plurality of service outlets, of the same or different type. By this is meant, for example, that one component chamber may house both a duplex electrical receptacle and a service outlet for connection of a television to cable television service. As will be appreciated, the integrated service outlet housings of the invention may be configured to receive any type of service outlet. Preferred service outlets include electrical receptacles, light switches, and data ports.

In other embodiments, the integrated service outlet housings comprise a plurality of component chambers arrayed about a user access chamber, preferably a user access chamber disposed centrally in relation to the various component chambers. In such embodiments, most often the various component chambers share a different sidewall or portion thereof with the user access chamber, as compared to the other component service chamber(s). Representative examples include embodiments where two, three, four, five, six, seven, eight, nine, ten, or more component chambers are arrayed about a central user access chamber. Particularly preferred embodiments include those where at least one pair of component chambers are arrayed about a central user access chamber such that each member of the pair is substantially opposite the other member of the pair.

Because the instant integrated service outlet housings are intended for use in the construction of buildings, they will preferably include at least one mounting bracket so that the housing can be fixedly attached to a structure, such as a metal or wooden framing stud. In many embodiments, the housing of the invention will include a plurality of mounting brackets positioned at various locations about the housing so that the housing may be easily attached to the particular structure. Of course, in embodiments where the framing system used does not employ stud-in-wall construction, but instead involves, for example, panelized wall systems, the integrated service outlet housing may not require one or more mounting brackets. In such embodiments, it may instead be preferred to include one or more other elements designed to extend from the outer surface of the housing that will be disposed, for example, in the foam used in a panelized wall system. Such elements may serve to hold the housing in a desired location during the process of producing the panel.

Upon installation and disposition of the various service outlets an integrated service outlet housing, the component chamber(s) housing the various service outlets and the exposed upper edges of the component chamber and user access chamber sidewalls will be still be visible. Accordingly, it is preferred that one more trim pieces be attached to the housing to conceal the various component chambers, service outlet connections with their respective services, and upper sidewall edges in order to provide an appropriate finished appearance. To attach trim pieces, the housings of the invention thus preferably also include at least one trim piece attachment element.

Thus, a related aspect of the invention concerns kits that include an integrated service outlet housing as described herein and the trim piece(s) designed for attachment thereto. Preferably, such kits include an integrated service outlet housing, the trim piece(s) designed for attachment thereto, and the hardware, if any, needed for attachment of the trim piece(s) to the integrated service outlet housing. Other features and advantages of the invention will be apparent from the following drawings, detailed description, and appended claims.

Various features and advantages of the invention will appear from the following description in which the preferred embodiments have been set forth in detail in conjunction with the accompanying drawings.

### BRIEF DESCRIPTION OF THE FIGURES

FIG. 1 shows an exploded isometric view from the front of an integrated service outlet housing according to the invention and a trim piece therefore. The housing shown comprises a component chamber adjacent to and sharing a sidewall with a user access chamber.

FIG. 2 shows an exploded isometric view from the front of an integrated service outlet housing according to the invention and a trim piece therefore, wherein the housing comprises two component chambers arrayed about a single user access chamber.

### DETAILED DESCRIPTION

As those in the art will appreciate, the following detailed description describes certain preferred embodiments of the invention in detail, and is thus only representative and does not depict the actual scope of the invention. Before describing the present invention in detail, it is understood that the invention is not limited to the particular aspects and embodiments described, as these may vary. It is also to be understood that the terminology used herein is for the purpose of describing particular embodiments only, and is not intended to limit the scope of the invention defined by the appended claims.

Light switches, outlets for services such as electricity, telephone, stereo, cable or satellite television and/or high speed Internet access, etc. are typically mounted to flat surfaces such as walls, ceilings, and floors. For safety and other reasons, these devices are generally not directly attached to building structures, but are instead disposed in various housing configured to receive them. The design, manufacture, and installation of these housings, and the various wiring attached to the service outlets disposed therein, are frequently dictated by building or other codes, rules, or regulations.

In most production construction applications, the dimensions of such housings are not only dictated by code requirements, but also by the physical constraints of the ultimate installation. For example, most conventionally framed home and office walls are built using steel or wooden members that are nominally 1.5 inches wide and 3.5 inches deep. Stud (i.e., the members that extend between the floor and ceiling plates) length depends on the desired distance between floor and ceiling. As a result, the interior of many walls allows for a maximum housing depth of only about 3.5 inches. When one considers that most service outlets have depth of at least 1 inch, and frequently more than 1.5 inches, particularly following connection to the wiring that provides the particular service for which the outlet provides connectivity, it is apparent that there is little room left in which to provide a recess.

This invention concerns integrated service outlet housings that provide substantial recesses to allow connection of various appliances and devices to service outlets. The integrated service outlet housings of the invention include at least one user access chamber and at least one accessible component chamber substantially adjacent to a user access chamber. Such housings allow service outlets, such as electrical receptacles, light switches, telephone jacks, cable or satellite jacks, to be mounted in a recessed fashion through the user access chamber such that plugs (or other suitably configured connectors) connected to such a service outlet do not protrude from the room-facing surface of a wall inside which the housing is mounted. On the other hand, the component chamber(s) adjacent to a user access chamber define a cavity sized to receive a service outlet and the wiring connected thereto needed to provide the particular service, for example, electrical wiring needed to provide electricity to a light switch or electrical receptacle. The user access chamber(s) and component chamber(s)are open, and when installed in a wall, may be readily accessed, before or after installation of the material used to sheet the wall frame. After the sheeting material is installed and finished (e.g., with paint, wall paper, paneling, etc.), trim pieces may be mounted to provide a finished appearance and conceal any openings between edges of the housing and opening in the sheeting material.

Frequently, the wall in which an integrated service outlet housing is to be installed will be sheeted after (in new construction) or before (in retrofit applications) on both sides of the wall frame with a material, for example, wallboard, lathe and plaster, wood paneling, siding, stucco, masonry, and/or the like attached to an underlying frame, which typically is comprised of wood or steel. Thus, the space inside the wall contains many open regions. As those in the art will appreciate, a housing according to the invention, when installed in a wall frame framed using conventional materials (e.g., steel or wooden 2×4 studs and plates), may have a depth as deep as the framing material used to form the wall frame (in the case of a typical wooden stud, about 3.5 inches, or about 9 cm). In this way, the maximum depth of the housing will essentially be equivalent to the distance between the interior surfaces of the sheeting material used to face the wall frame, once secured in place on the wall frame. Because the user access chamber(s) and component chamber(s) are arrayed side-by-side, as opposed to one behind or overlapping with the other, the user access chamber can be as deep as the particular wall will allow. Moreover, because of this configuration, the easily accessible component chambers provide the room needed to house the various service outlets to be associated with the housing in a given installation, along with any necessary wiring connections.

As those in the art will appreciate, the minimum volume within a component chamber will largely be determined by the dimensions of the service outlet the chamber is intended to house and the connection requirements for connecting the wires needed to deliver the intended service to the service outlet. In preferred embodiments, each component chamber of an integrated service outlet housing will be sized to accommodate any possible service outlet. In this way, the component chamber will be universal, in that any desired service outlet can be disposed therein in a particular application. Of course, in some embodiments it may be desired to provide a component chamber of a particular size, for use with only one or, at most, several different types of service outlets.

Similarly, the dimensions of a user access chamber will largely be determined by consideration of the number and type of appliances and devices to receive service from the particular integrated service outlet housing. Preferably, a user access chamber will be of sufficient volume and dimensions to allow easy connection of cords, cables, and wires from the appliances to the service outlets disposed in the housing in way that minimizes protrusion of the cords, cables, and wires outwardly from the wall. In this way the housings of the invention will facilitate flush mounting of appliances and devices to the wall.

Integrated service outlet housings and trim pieces according to the invention are preferably made of one or more materials, typically metal or plastic, having appropriate electrical insulation characteristics. Any suitable process can be used to manufacture the housings and face plates, including stamping, casting, and molding. When plastics are used to make housings and trim pieces, a particularly preferred process is injection molding.

As will be appreciated, a component chamber and a user access chamber share all or some of a sidewall, such that an opening in the side wall allows the service outlet ultimately mounted in the component chamber to be accessed from the user access chamber for connection to an appliance or other device requiring service of the type provided by the service outlet. In some embodiments comprising multiple user access chambers and/or component chambers, the opening(s) in the sidewalls between the access and component chambers may not be fully formed. Instead, they may be pre-defined by perforating or fatiguing material in the sidewall to allow removal of one or more pieces of material, the subsequent removal of which actually forms the opening, akin to the way pre-formed knockouts can be removed to provide wire ports in a component chamber. In this way, a single housing can serve to provide, for example, one, two, three, four, or more component chambers arrayed about a central user access chamber. Depending on the particular application, it may not be necessary to actually remove the intervening material between the user access chamber and all of the adjoining component chambers, as could be the case, for example, when only two component chambers of a four component chamber, one user access chamber housing are needed.

Preferably, a sidewall between a user access and component chamber also includes one or more mounting structures for fixedly mounting a service outlet in the component chamber, preferably after the necessary wiring connections have been made between the particular wire(s) for delivery of the desired service and the connectors on the service outlet (e.g., the positive, negative, and ground terminals on a grounded electrical receptacle). Often, these mounting structures comprise an element for engaging a fastener such as a screw.

In many embodiments, an integrated service outlet housing will also include at least one mounting bracket to allow the housing to be fixedly attached, for example, to a stud in a wall, in any suitable manner. In some of these embodiments, the mounting brackets will be guides for fasteners such as screws or nails to facilitate mounting during, for example, new construction prior to installation of sheeting material used to cover a wall frame. Indeed, in a particularly preferred embodiment, a fastener suited for use in conjunction with the particular mounting bracket type will be included, or even pre-positioned in the mounting bracket, in a kit that includes the housing, one or more trim pieces, and hardware needed to mount the trim piece(s) to the housing following installation pre-positioned.

Preferably, to finish installation of a housing of the invention, the outer edges of an integrated service outlet housing are aligned with an opening in the sheeting material (e.g., wallboard). Attachment of a trim piece (e.g., a cover plate) designed for use in conjunction with the housing conceals the housing. In general, a trim piece for attachment to an integrated service outlet housing according to the invention will comprise a flange portion sized to extend laterally beyond the opening in the sheeting material following attachment to the housing. The trim piece may be attached in any suitable fashion. For example, one or more fasteners, such as screws, may be used to mount the trim piece to the housing. In such embodiments, the trim piece typically includes holes through which screws may be inserted to engage threads or another similar element appropriately positioned in the housing to engage each screw. In another representative embodiment, one or more clips disposed on the inner face of the trim piece can engage appropriately positioned holes in the housing, thereby allowing the trim piece to be secured to the housing in a manner that provides an attractive, aesthetically pleasing finish to the housing/trim piece combination. It will be appreciated that a trim piece could also include one or more sliding, pivoting, snap on, or other type of doors or covers.

It will also be appreciated that, in addition to a trim piece used to provide a finished appearance to an integrated service outlet housing by covering any openings between the sheeting material and housing, trim pieces such as face plates, etc. may also be used in conjunction an opening in a side wall shared between a user access chamber and a component chamber. For example, if an integrated service outlet housing is fabricated such that an opening for accessing and mounting a service outlet is present in each sidewall shared between a user access chamber and a component chamber intended to house a duplex electrical receptacle, it may be desirable to include a trim piece such as a face plate for a duplex electrical receptacle. Alternatively, if one or more of the component chambers in a multi-component chamber integrated service outlet housing are not to be used in a particular application, it may be desirable to provide a trim piece such as a face plate with no opening in order to cover the opening that would otherwise exist in the sidewall between the user access chamber and the unused component chamber.

In use, for new construction, an integrated service outlet housing is typically mounted to a wall stud or other framing piece. Appropriate knockouts are removed from the component chamber(s) to be used to form wire ports and, if necessary, openings in the sidewalls between the component chambers to be used and the user access chamber, and cables providing the desired service(s) are passed into the respective component chambers. Appropriate connections are made with terminals on the service outlets to be installed in the housing. The service outlets are then mounted in their respective component chambers, making their respective jacks, receptacles, etc. accessible through the user access chamber. After the desired sheeting material is installed, trim pieces are mounted to the housing.

For retrofit (e.g., remodeling) applications, an opening is made in the sheeting material covering one side of a wall. The opening is sized sufficiently to allow the particular integrated service outlet housing to be used to be inserted into the opening, after which is secured to one or more members used to form the wall frame. Appropriate knockouts may be removed before or after attachment to the wall frame to form wire ports and, if necessary, openings in sidewalls between one or more component chambers and the user access chamber. Most often, cables providing the desired service(s) are then passed into the respective component chambers and appropriate connections are made with terminals on the service outlets to be installed in the housing. The installation then proceeds to completion.

### EXAMPLES OF REPRESENTATIVE EMBODIMENTS

The following examples are provided to illustrate certain representative embodiments of the present invention and to aid those of skill in the art in practicing the invention. As representative of the myriad of embodiments within the scope of this invention, these examples are in no way to be considered to limit the scope of the invention as claimed in any manner.

### Example 1

### Housing with One User Access Chamber and One Component Chamber

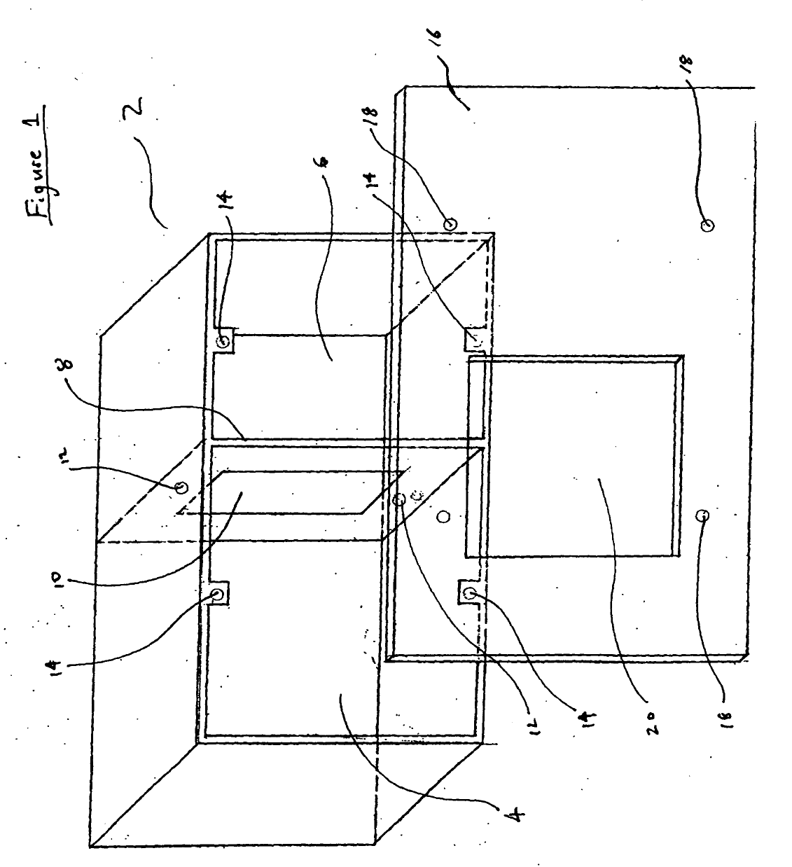

This example describes the embodiment depicted in FIG. 1. This embodiment shows an integrated service outlet housing (2) that contains a user access chamber (4) and a component chamber (6) for housing a service outlet such as a duplex electrical receptacle (not shown). In this embodiment, the user access chamber (4) and component chamber (6) share a sidewall (8) that has an opening (10) formed therein. Following installation of the desired service outlet in component chamber (6), the opening (10) allows a user to connect an appliance to, for example, a data port or receptacle in the service outlet so that the desired service (e.g., telecommunications, electricity, etc.) can be delivered to the appliance.

In the depicted embodiment, shared sidewall (8) also contains two holes (12) for use in mounting the service outlet (not shown). Similarly, the housing (2) also contains additional holes (14) for use in mounting a trim piece (16) to the housing after the housing has been installed in the wall and the desired service outlet has been mounted in the component chamber (6). The trim piece also contains mounting holes (18) and an access port (20) through which the user access chamber (4) can be accessed.

### Example 2

### Housing with One User Access Chamber and Two Component Chambers

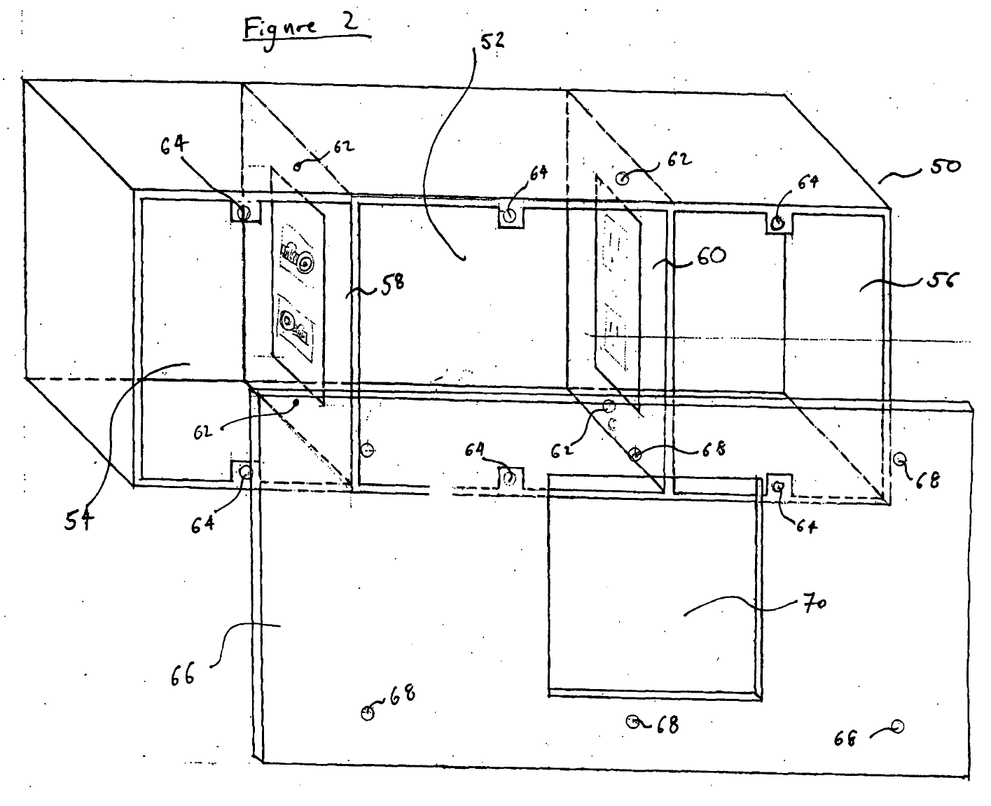

This example describes the embodiment depicted in FIG. 2. This embodiment shows an integrated service outlet housing (50) that contains a user access chamber (52) disposed between two component chambers (54, 56) each designed for housing a service outlet (not shown) such as a duplex electrical receptacle, data port, etc. In this embodiment, the user access chamber (52) shares a different sidewall (58, 60) with each component chamber (54, 56, respectively). As shown, each shared sidewall (58, 60) contains an opening (62, 64, respectively) formed therein. Following installation of the desired service outlet in the component chamber (54, 56), the openings (58, 60) allow a user to connect an appliance to, for example, a data port or receptacle in the service outlet so that the desired service (e.g., telecommunications, electricity, etc.) can be delivered to the appliance.

In the depicted embodiment, the shared sidewalls (58, 60) also each contain two holes (62) for use in mounting the service outlets (not shown). Similarly, the housing (50) also contains additional holes (64) for use in mounting a trim piece (66) to the housing after the housing has been installed in the wall and the desired service outlets have been mounted in the component chambers (54, 56). The trim piece also contains mounting holes (68) and an access port (70) through which the user access chamber (52) can be accessed.

All of the articles and methods disclosed and claimed herein can be made and executed without undue experimentation in light of the present disclosure. While the articles and methods of this invention have been described in terms of preferred embodiments, it will be apparent to those of skill in the art that variations may be applied without departing from the spirit and scope of the invention. All such variations and equivalents apparent to those skilled in the art, whether now existing or later developed, are deemed to be within the spirit and scope of the invention as defined by the appended claims.

All patents, patent applications, and publications mentioned in the specification are indicative of the levels of those of ordinary skill in the art to which the invention pertains. All patents, patent applications, and publications are herein incorporated by reference in their entirety for all purposes and to the same extent as if each individual publication was specifically and individually indicated to be incorporated by reference in its entirety for any and all purposes.

The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

I claim:

1. An integrated service outlet housing, comprising:
a. a user access chamber, comprising a back wall and one or more side walls extending from the back wall; and
b. a component chamber substantially adjacent to the user access chamber, comprising a back wall, one or more side walls extending from the back wall, and at least one wire port, wherein the component chamber is adapted for housing at least one service outlet,
wherein the user access chamber and the component chamber share a side wall or portion thereof, wherein the shared side wall or portion thereof comprises at least one opening for disposition of the service outlet(s) such that a user can access the service outlet, and wherein the service outlet housing is configured for use with conventional construction framing.

2. An integrated service outlet housing according to claim 1 wherein the component chamber is adapted for housing a plurality of service outlets.

3. An integrated service outlet housing according to claim 1 wherein the service outlet is selected from the group consisting of an electrical receptacle, an electrical switch, and a data port.

4. An integrated service outlet housing according to claim 1 comprising a plurality of component service chambers arrayed about the user access chamber, wherein each component chamber shares a different side wall or portion thereof with the user access chamber as compared to the other component service chamber(s).

5. An integrated service outlet housing according to claim 1 wherein the user access chamber includes four sidewalls that, with the back wall, form a substantially rectangular open box.

6. An integrated service outlet housing according to claim 5 that comprises a plurality of component chambers arrayed about the user access chamber, wherein each component chamber shares a different sidewall with the user access chamber as compared to the other component chamber(s).

7. An integrated service outlet housing according to claim 6 that comprises a first and a second component chamber each arrayed opposite the other in relation to the user access chamber.

8. An integrated service outlet housing according to claim 1 wherein the side wall(s) extend substantially perpendicularly from the back wall.

9. An integrated service outlet housing according to claim 1 wherein the shared side wall(s) extend obtusely from the back wall of the service outlet access chamber.

10. An integrated service outlet housing according to claim 1 further comprising at least one mounting bracket for mounting the electrical outlet housing.

11. An integrated service outlet housing according to claim 1 further comprising at least one trim piece attachment element.

12. An integrated service outlet housing according to claim 11 further comprising a trim piece fixedly attached thereto.

13. A kit comprising an integrated service outlet housing according to claim 1 and a trim piece configured for attachment thereto.
